(19) United States
(12) Patent Application Publication
(10) Pub. No.: US 2006/0117838 A1
(43) Pub. Date: Jun. 8, 2006

(54) Deepwater seal test apparatus

(75) Inventor: Michael R. Williams, Houston, TX (US)

Correspondence Address: Henry C. Query, Jr., 504 S. Pierce Avenue, Wheaton, IL, 60187, US

(73) Assignee: FMC Technologies, Inc., Chicago, IL (US)

(21) Appl. No.: 11/007,778

(22) Filed: Dec. 7, 2004

(51) Int. Cl. G01M 3/04

(52) U.S. Cl. 73/46; 73/49.8

(57) ABSTRACT

A seal test apparatus for a subsea hydrocarbon production system having first and second components that are sealed by a primary seal and an external barrier seal comprises a pressure chamber which is connectable to a source of pressure, a suction chamber which is connectable to a volume between the first and second seals, and a movable member which comprises a first surface that is exposed to the pressure chamber and a second surface that is exposed to the suction chamber. In operation, the introduction of pressure into the pressure chamber moves the movable member and thereby creates a vacuum in the suction chamber, and this vacuum is communicated to the volume in order to test the ability of the second seal to prevent pressure from the ambient environment from entering the volume.

### BACKGROUND OF THE INVENTION

The present invention is directed to an apparatus for testing an external barrier seal in a subsea hydrocarbon production system. More specifically, the invention is directed to such an apparatus which applies a vacuum across the seal to simulate the pressure from the ambient environment that the seal will experience in service.

Subsea hydrocarbon production systems which are deployed in deep water must be designed to resist both internal and external pressures. During operation of such systems, the internal pressures are normally much higher than the external pressures from the surrounding seawater. Accordingly, the seals which are positioned between the various components of these systems must be able to reliably retain the internal pressures. In the past, these seals have been designed to be “pressure energized”, such that the internal pressures produce a force on the seals which makes them seal tighter as the pressure increases.

However, under certain circumstances the internal pressures may fall to levels well below the external pressures. Such circumstances can occur during the initial installation and commissioning of the subsea hydrocarbon production system and when the system is depressurized, for example during shut in. In these reverse pressure situations, the seals which are positioned between the various components must be able to reliably prevent the ingress of seawater. However, conventional pressure energized seals have a limited capability to seal pressure in the reverse direction.

Thus, in many subsea hydrocarbon production systems an external barrier seal is often positioned outboard of the primary seal to prevent seawater from reaching the primary seal. In this arrangement, the primary seal contains the internal pressures within the system and the external barrier seal prevents the ingress of seawater into the system. This system thus allows for the optimization of each seal for its intended purpose, rather than forcing a single seal to work in both directions.

In the past, the primary seal and the external barrier seal have been tested by using a Remotely Operated Vehicle (“ROV”) to inject pressure into the cavity between these seals. However, this test method results in a reverse pressure being applied to the primary seal which may actually damage the seal. Also, since this test method pressurizes the external barrier seal from the inside, it does not truly confirm the ability of the seal to prevent the ingress of seawater.

### SUMMARY OF THE INVENTION

In accordance with the present invention, these and other disadvantages in the prior art are overcome by providing a seal test apparatus for use in conjunction with a subsea hydrocarbon production system which includes at least first and second components, a first seal which is positioned between the first and second components, and a second seal which is positioned between the first and second components and between the first seal and the ambient environment. The seal test apparatus comprises a pressure chamber which is connectable to a source of pressure, a suction chamber which is connectable to a volume between the first and second components that is enclosed by the first and second seals, and a movable member which comprises a first surface that is exposed to the pressure chamber and a second surface that is exposed to the suction chamber. In operation, the introduction of pressure into the pressure chamber moves the movable member and thereby creates a vacuum in the suction chamber, and this vacuum is communicated to the volume in order to test the ability of the second seal to prevent pressure from the ambient environment from entering the volume.

In accordance with one embodiment of the invention, the source of pressure is located on an ROV. For example, the source of pressure may comprise the existing hydraulic power system of the ROV.

In accordance with a further embodiment of the invention, the seal test apparatus also comprises a female hot stab receptacle which is fluidly connected to the pressure chamber, and the ROV comprises a male hot stab which is fluidly connected to the source of pressure and which is insertable into the female hot stab receptacle to fluidly connect the source of pressure to the pressure chamber.

In accordance with another embodiment of the invention, the seal test apparatus also comprises a male hot stab which is fluidly connected to the suction chamber, and the subsea hydrocarbon production system comprises a seal test receptacle which is fluidly connected to the volume. In operation, the male hot stab is inserted into the seal test receptacle to fluidly connect the suction chamber to the volume.

In accordance with yet another embodiment of the invention, the seal test apparatus also includes means for monitoring the pressure in the volume. For example, the seal test apparatus may include a pressure gage which is fluidly connected to the suction chamber or the source of pressure. Alternatively or in addition to the pressure gage, the seal test apparatus may include a visual position indicator, such as a rod, which is connected to the movable member.

Thus, the seal test apparatus of the present invention uses “suction”, rather than pressure, to confirm that the external barrier seal will exclude seawater when the subsea hydrocarbon production system is fully depressurized. Consequently, the risk of damage to the primary seal is minimized during the testing procedure. In addition, the testing procedure provides a more accurate indication of the sealing integrity of the external barrier seal since it simulates the direction of the pressure that this seal will see in service.

These and other objects and advantages of the present invention will be made apparent from the following detailed description, with reference to the accompanying drawings.

### BRIEF DESCRIPTION OF THE DRAWINGS

FIG. 1 is a schematic representation of the deepwater seal test apparatus of the present invention shown in conjunction with a subsea completion assembly; and

FIG. 2 is a cross sectional representation of the deepwater seal test apparatus of FIG. 1.

### DETAILED DESCRIPTION OF THE PREFERRED EMBODIMENTS

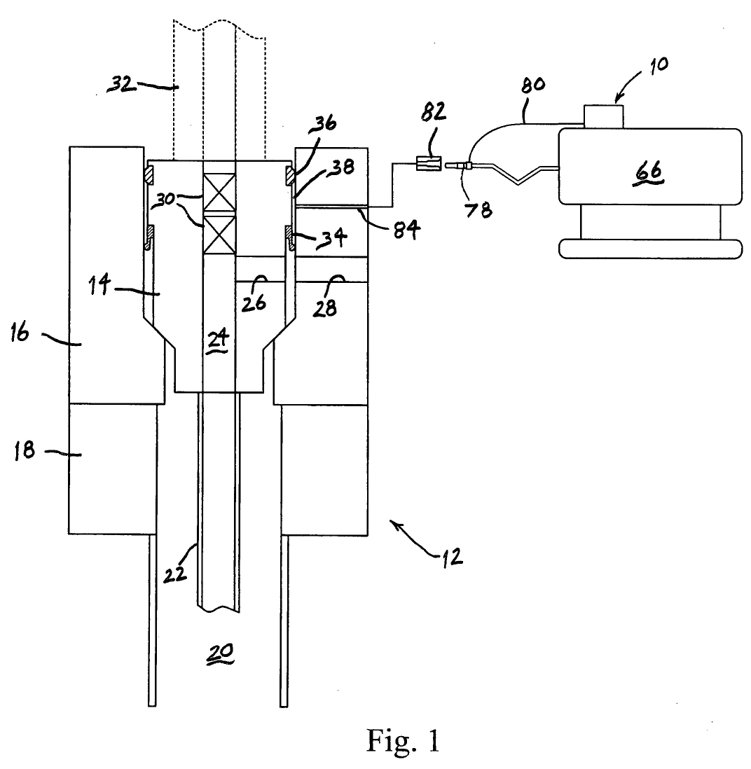

Referring to FIG. 1, the deepwater seal test apparatus of the present invention, which is indicated generally by reference number 10, is shown in conjunction with a subsea hydrocarbon production system 12 which comprises a first component 14 that is connected to a second component 16. In the context of the present invention, the hydrocarbon production system 12 can be any assembly of components which is used in the production, storage or transport of oil or gas from a subsea well, such as a completion assembly, a wellhead, a Christmas tree, a flow loop, a flowline, a jumper, a riser or a pipeline. For purposes of simplicity, however, the hydrocarbon production system 12 is shown in FIG. 1 to be a subsea completion assembly which includes a tubing hanger that is installed in a Christmas tree, wherein the tubing hanger is the first component 14 and the Christmas tree is the second component 16.

As shown in FIG. 1, the Christmas tree 16 is connected to a wellhead 18 which is installed over a well bore 20, and the tubing hanger 14 supports a tubing string 22 which extends through the well bore to the subterranean hydrocarbon formation. The tubing hanger includes an axial production bore 24 which is fluidly connected to both the tubing string 22 and a lateral production passage 26 that communicates with a production outlet 28 in the Christmas tree 16. In the production mode of operation of the completion assembly 12, one or more plugs 30 are installed in the production bore 24 above the production passage 26 to direct the well fluids in the well bore through the production outlet 28 and into a flowline or similar hydrocarbon production system (not shown). In the installation and workover modes of operation of the completion assembly 12, a tubing hanger running tool (“THRT”) 32 which is in fluid communication with a surface facility (not shown) is connected to the production bore 24, the production outlet 28 is closed, and the plugs 30 are removed to thereby fluidly connect the well bore to the surface facility.

Thus, in both the production mode of operation and the installation and workover modes of operation of the completion assembly 12, the tubing hanger 14 and the Christmas tree 16 define a portion of a flow passage which extends between the well bore and either a flowline or the surface facility. Therefore, the tubing hanger 14 must be sealed to the Christmas tree 16 in order to prevent the escape of well fluids from the flow passage into the environment and to prevent the ingress of sea water from the environment into the flow passage.

Accordingly, the completion assembly 12 typically includes a primary seal 34 which is positioned between the tubing hanger 14 and the Christmas tree and an external barrier seal 36 which is positioned between the tubing hanger and the Christmas tree and between the primary seal and the environment. The function of the primary seal 34 is to retain the well fluids within the flow passage defined by the tubing hanger 14 and the Christmas tree 16, while the function of the external barrier seal 36 is to prevent the ingress of sea water from the environment into this flow passage.

Prior to placing the completion assembly 12 into service, both the primary seal 34 and the external barrier seal 36 must be pressure tested to determine whether they will function as required. In the past, the external barrier seal 36 was tested by injecting pressurized fluid into the annular space 38 bounded by these seals. As noted above, however, this does not simulate the ambient pressure acting on the external barrier seal 36 and can result in the primary seal 34 being damaged.

In accordance with the present invention, therefore, the external barrier seal 36 is pressure tested by creating a vacuum in the annular space using the seal test apparatus 10. This will result in the creation of a pressure differential across the external barrier seal 36 which is similar to what the seal will experience in service. Accordingly, the seal test apparatus 10 is able to test the sealing integrity of the external barrier seal 36 under more accurate pressure conditions.

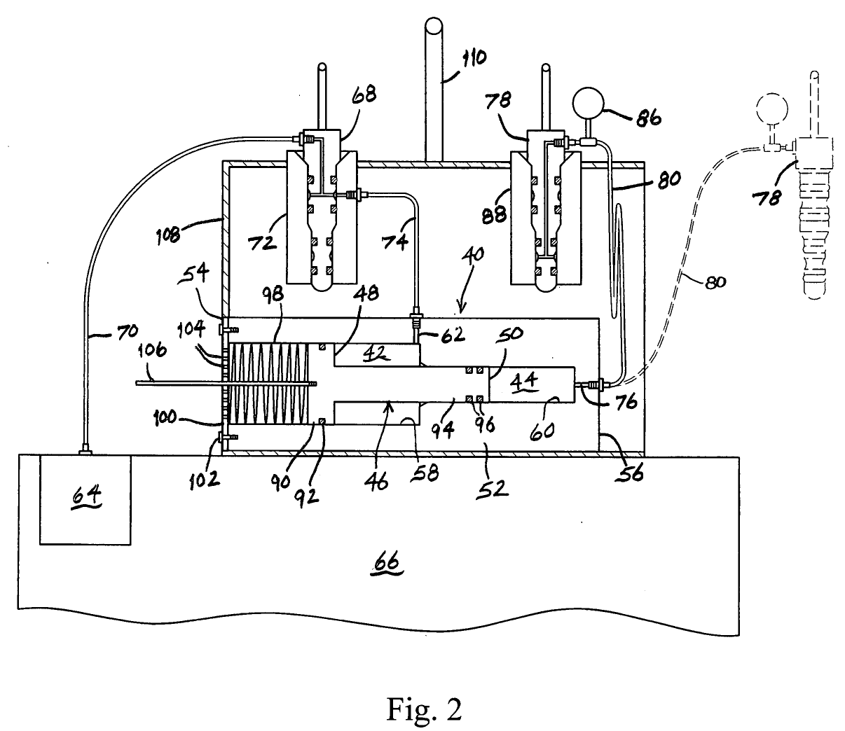

Referring to FIG. 2, the seal test apparatus 10 includes a suction device 40 which comprises a pressure chamber 42 that is connectable to a source of pressure, a suction chamber 44 that is connectable to the annular space 38, and a movable member 46 that includes a first surface 48 which is exposed to the pressure chamber and a second surface 50 that is exposed to the suction chamber. In operation, pressure in the pressure chamber 42 forces the movable member 46 to move and thereby draw a vacuum in the suction chamber 44. Thus, the suction device 40 inverts and preferably also multiplies the pressure in the pressure chamber 42 to create a relatively high vacuum in the suction chamber 44 which can be used to test the external barrier seal 36.

In the exemplary embodiment of the invention shown in FIG. 2, the suction device 10 includes an elongated body 52 which comprises a first end 54 and a second end 56. The pressure chamber 42 is defined by a first bore 58 which extends generally axially through the body 52 from the first end 54, and the suction chamber 44 is defined by a second bore 60 which extends generally axially through the body from the first bore toward to second end 56. In addition, the diameter of the first bore 58 is preferably larger than the diameter of the second bore 60 for reasons which will be made apparent below.

The body 52 also includes a pressure port 62 which communicates with the pressure chamber 42 and is connectable to a source of preferably hydraulic pressure. In one embodiment of the invention, the source of hydraulic pressure is an existing hydraulic power system 64 on an ROV 66. Accordingly, the seal test apparatus 10 does not require its own source of hydraulic pressure. The hydraulic power system 64 is connected to a first standard male ROV hot stab 68 by, for example, a first hose 70. To facilitate the connection of the first male hot stab 68 with the suction device 40, the seal test apparatus 10 ideally includes a conventional ROV female hot stab receptacle 72 into which the first male hot stab can be inserted. The female hot stab receptacle 70 in turn is connected to the pressure port 62 by a second hose 74. In use of the seal test apparatus 10, therefore, the hydraulic power system 64 is connected to the pressure chamber 42 by plugging the first male hot stab 68 into the female hot stab receptacle 72.

The body 52 of the suction device 40 also comprises a suction port 76 which communicates with the suction chamber 44 and is connectable with the annular space 38 between the primary seal 34 and the external barrier seal 36. In an exemplary embodiment of the invention, the seal test apparatus 10 includes a second standard male ROV hot stab 78 which is connected to the suction port 76 by a preferably high collapse-resistant hose 80. As shown in FIG. 1, in use of the seal test apparatus 10, the second male hot stab 78 is inserted into a conventional seal test receptacle 82 on the completion assembly 12 which is connected to a seal test port 84 in, for example, the Christmas tree 16 that in turn communicates with the annular space 38. This procedure may be performed by the ROV in a known manner. Although not required, the seal test apparatus 10 ideally also includes a pressure gage 86 to measure the vacuum in the annular space 38, and a dummy female hot stab receptacle 88 in which the second male hot stab 78 may be parked when not in use.

In the embodiment of the invention which is illustrated in the Figures, the movable member 46 is a piston which includes a head portion 90 that is sealed to the first bore 58 by a suitable first seal 92 and a stem portion 94 that is sealed to the second bore 60 by a number of suitable second seals 96. The first surface 48 of the piston 46 is the face of the head portion 90 which is exposed to the pressure chamber 42, and the second surface 50 of the piston is the face of the stem portion 94 which is exposed to the suction chamber 44. Thus, when the second male hot stab 78 is inserted into the seal test receptacle 82 and hydraulic pressure is pumped into the pressure chamber 42, the piston 46 will move to the left (as viewed in FIG. 2) and thereby create a vacuum in the suction chamber 44 and the annular space 38.

As is apparent from FIG. 2, the area A₁ of the first surface 48 is larger than the area A₂ of the second surface 50. Consequently, the absolute value of the pressure in the suction chamber 44 will be larger than the pressure in the pressure chamber 42 by a factor of A₁/A₂. Therefore, by properly configuring the first and second surfaces 48, 50, the available pressure from the ROV's hydraulic power supply 64, which is typically about 3,000 psi or more, can produce a vacuum of about 4,000 psi or more in the annular space 38.

The suction device 40 preferably also includes a spring 98 or similar means for returning the piston 46 to its initial position in the absence of pressure in the pressure chamber 42. The spring 98 is positioned between the head portion 90 and an end cap 100 which is secured to the first end 54 of the body 52 by suitable means, such as screws 102. In addition, the end cap 100 preferably includes a plurality of relatively small holes 104 to facilitate the movement of the piston 46 within the bores 58 and 60.

In operation of the seal test apparatus 10, the first male hot stab 68 is inserted into the female hot stab receptacle 72 and the second male hot stab 78 is inserted into the seal test receptacle 82 on the completion assembly 12. The ROV 66 is then activated to pump hydraulic pressure into the pressure chamber 42 at a pressure sufficient to produce the desired vacuum in the annular space 38. The pressure in the pressure chamber 42 is then locked in, for example by an isolation valve (not shown) in the hydraulic power supply 64, and the seal test apparatus 10 is monitored for a period of time, such as a few minutes, to determine whether the sealing integrity of the external barrier seal 36 is sufficient to retain the vacuum in the annular space 38.

In this regard, the vacuum in the annular space 38 can be monitored with the pressure gage 86 or by an existing pressure gage in the ROV's hydraulic power supply 64. Alternatively or in addition to these pressure gages, the seal test apparatus 10 may comprise a visual position indicator to monitor the position of the piston 46 and, thus, the sealing integrity of the external barrier seal 36. Referring again to FIG. 2, the visual position indicator may comprise a rod 106 which is attached to the piston 46 and extends through a corresponding hole in the end cap 100. Unless the external barrier seal 36 is not sealing properly, the piston 46 should only move a relatively small portion of its full stroke before the vacuum is developed in the annular space 38. However, if the external barrier seal 36 leaks, the piston 46 will continue to move to the left. In either case, the rod 106 will provide a visual indication of the position of the piston 46 and, thus, the sealing integrity of the external barrier seal 36.

The components of the seal test apparatus 10 may be incorporated into a conventional ROV or, as shown in FIG. 2, mounted in a separate housing 108. In addition, the housing 108 may either be connected to the ROV 66 or simply carried by the ROV to the completion apparatus 12, in which event the housing 108 is preferably provided with an ROV handle 110. In addition, due to its relatively small size, one or more of the components of the seal test apparatus 10, such as the suction device 40, may be constructed of a CRA material without making the apparatus unduly expensive.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

What is claimed is:

1. A seal test apparatus for use in conjunction with a subsea hydrocarbon production system which includes at least first and second components, a first seal which is positioned between the first and second components, and a second seal which is positioned between the first and second components and between the first seal and the ambient environment, the seal test apparatus comprising:
a pressure chamber which is connectable to a source of pressure;
a suction chamber which is connectable to a volume between the first and second components that is enclosed by the first and second seals; and
a movable member which comprises a first surface that is exposed to the pressure chamber and a second surface that is exposed to the suction chamber;
wherein the introduction of pressure into the pressure chamber moves the movable member and thereby creates a vacuum in the suction chamber; and
wherein the vacuum is communicated to the volume in order to test the ability of the second seal to prevent pressure from the ambient environment from entering the volume.

2. The seal test apparatus of claim 1, wherein the source of pressure is located on an ROV.

3. The seal test apparatus of claim 2, wherein the source of pressure comprises a hydraulic power system of the ROV.

4. The seal test apparatus of claim 2, further comprising:
a female hot stab receptacle which is fluidly connected to the pressure chamber;
wherein the ROV comprises a male hot stab which is fluidly connected to the source of pressure and which is insertable into the female hot stab receptacle to fluidly connect the source of pressure to the pressure chamber.

5. The seal test apparatus of claim 1, further comprising:
a male hot stab which is fluidly connected to the suction chamber;
wherein the subsea hydrocarbon production system comprises a seal test receptacle which is fluidly connected to the volume; and
wherein the male hot stab is insertable into the seal test receptacle to fluidly connect the suction chamber to the volume.

6. The seal test apparatus of claim 1, further comprising means for monitoring the pressure in the volume.

7. The seal test apparatus of claim 6, wherein the monitoring means comprises a pressure gage which is fluidly connected to the suction chamber.

8. The seal test apparatus of claim 6, wherein the monitoring means comprises a pressure gage which is fluidly connected to the source of pressure.

9. The seal test apparatus of claim 6, wherein the monitoring means comprises a visual position indicator which is connected to the movable member.

10. The seal test apparatus of claim 9, wherein the visual position indicator comprises a rod which is connected to the movable member.

11. A seal test apparatus for use in conjunction with a subsea hydrocarbon production system which includes at least first and second components, a first seal which is positioned between the first and second components, and a second seal which is positioned between the first and second components and between the first seal and the ambient environment, the seal test apparatus comprising:
a suction device which includes a body, a first bore that extends at least partially through the body, and a second bore that extends at least partially through the body and is connected to the first bore;
a pressure chamber which is defined by at least a portion of the first bore and which is connectable to a source of pressure;
a suction chamber which is defined by at least a portion of the second bore and which is connectable to a volume between the first and second components that is enclosed by the first and second seals;
a movable member which is positioned in the body and which includes a first surface that is exposed to the pressure chamber and a second surface that is exposed to the suction chamber;
wherein the introduction of pressure into the pressure chamber moves the movable member and thereby creates a vacuum in the suction chamber; and
wherein the vacuum is communicated to the volume in order to test the ability of the second seal to prevent pressure from the ambient environment from entering the volume.

12. The seal test apparatus of claim 11, wherein the area of the first surface is greater than the area of the second surface.

13. The seal test apparatus of claim 11, wherein the source of pressure is located on an ROV.

14. The seal test apparatus of claim 12, further comprising:
a female hot stab receptacle which is fluidly connected to the pressure chamber;
wherein the ROV comprises a male hot stab which is fluidly connected to the source of pressure and which is insertable into the female hot stab receptacle to fluidly connect the source of pressure to the pressure chamber.

15. The seal test apparatus of claim 11, further comprising:
a male hot stab which is fluidly connected to the suction chamber;
wherein the subsea hydrocarbon production system comprises a seal test receptacle which is fluidly connected to the volume; and
wherein the male hot stab is insertable into the seal test receptacle to fluidly connect the suction chamber to the volume.

16. The seal test apparatus of claim 11, further comprising means for monitoring the pressure in the volume.

17. The seal test apparatus of claim 16, wherein the monitoring means comprises a pressure gage which is fluidly connected to the suction chamber.

18. The seal test apparatus of claim 16, wherein the monitoring means comprises a pressure gage which is fluidly connected to the source of pressure.

19. The seal test apparatus of claim 16, wherein the monitoring means comprises a visual position indicator which is connected to the movable member.

20. The seal test apparatus of claim 19, wherein the visual position indicator comprises a rod which is connected to the movable member.

21. A seal test apparatus for use in conjunction with a subsea hydrocarbon production system which includes at least first and second components, a first seal which is positioned between the first and second components, and a second seal which is positioned between the first and second components and between the first seal and the ambient environment, the seal test apparatus comprising:
a suction device which includes:
a body which comprises first and second ends;
a first bore which extends at least partially through the body from the first end;
a second bore which extends at least partially through the body from the first bore toward the second end;
wherein the first bore comprises a first diameter and the second bore comprises a second diameter that is smaller than the first diameter;
a pressure chamber which is defined by at least a portion of the first bore;
a suction chamber which is defined by at least a portion of the second bore; and
a piston which comprises a head portion that is sealed to the first bore and a stem portion that is sealed to the second bore;
means for connecting the pressure chamber to a source of pressure; and
means for connecting the suction chamber to a volume between the first and second components that is enclosed by the first and second seals;
wherein the introduction of pressure into the pressure chamber moves the piston and thereby creates a vacuum in the suction chamber; and
wherein the vacuum is communicated to the volume in order to test the ability of the second seal to prevent pressure from the ambient environment from entering the volume.

22. The seal test apparatus of claim 21, wherein the source of pressure is located on an ROV.

23. The seal test apparatus of claim 22, wherein the pressure chamber connecting means comprises a female hot stab receptacle which is fluidly connected to the pressure chamber, and wherein the ROV comprises a male hot stab which is fluidly connected to the source of pressure and is insertable into the female hot stab receptacle to fluidly connect the source of pressure to the pressure chamber.

24. The seal test apparatus of claim 21, wherein the suction chamber connecting means comprises a male hot stab which is fluidly connected to the suction chamber, and wherein the subsea hydrocarbon production system comprises a seal test receptacle which is fluidly connected to the volume and into which the male hot stab is insertable to fluidly connect the suction chamber to the volume.

25. The seal test apparatus of claim 21, further comprising means for monitoring the pressure in the volume.

26. The seal test apparatus of claim 25, wherein the monitoring means comprises a pressure gage which is fluidly connected to the suction chamber.

27. The seal test apparatus of claim 25, wherein the monitoring means comprises a pressure gage which is fluidly connected to the source of pressure.

28. The seal test apparatus of claim 25, wherein the monitoring means comprises a visual position indicator which is connected to the movable member.

29. The seal test apparatus of claim 28, wherein the visual position indicator comprises a rod which is connected to the piston and extends beyond the first end of the body.

30. The seal test apparatus of claim 21, further comprising means for returning the piston to an initial position in the absence of pressure in the pressure chamber.
